(19) United States
(12) Patent Application Publication
(10) Pub. No.: US 2025/0200328 A1
(43) Pub. Date: Jun. 19, 2025

(54) MACHINE LEARNING FRAMEWORK FOR PREDICTING INFLOW PERFORMANCE RELATIONSHIP IN COMPLEX RESERVOIRS

(71) Applicant: SAUDI ARABIAN OIL COMPANY, Dhahran (SA)

(72) Inventors: James Ohioma Arukhe, Dhahran (SA); Suhail A. Samman, Riyadh (SA); Rayed M. Al-Zayer, Tarout Island (SA)

(73) Assignee: SAUDI ARABIAN OIL COMPANY, Dhahran (SA)

(21) Appl. No.: 18/538,410

(22) Filed: Dec. 13, 2023

(51) Int. Cl. G06N 3/045; E21B 47/07; E21B 49/00; G06N 3/084

(52) U.S. Cl. CPC G06N 3/045; E21B 47/07; E21B 49/00; G06N 3/084; E21B 2200/20; E21B 2200/22

(57) ABSTRACT

A method for predicting the inflow performance relationship (IPR) for an oil and gas well and a reservoir in an oil and gas field. The method includes obtaining field data from the oil and gas field and obtaining a set of operation parameters related to the oil and gas field. The method further includes determining, with a hybrid machine learning (ML) model including at least one ML model, a predicted IPR based on the field data and in view of the set of operation parameters. The method further includes adjusting, with a well controller, the set of operation parameters based on, at least, the predicted IPR.

### BACKGROUND

Inflow performance relationship (IPR) is a key metric in reservoir and production engineering that generally describes the relationship between the pressure at the well and the flow rate of oil or gas from the well. Accurate prediction of IPR is crucial for optimal reservoir management and enables accurate and efficient planning and development of production strategies. However, the IPR is sensitive to many factors involving the well, the reservoir that the well accesses, and the fluid traveling between the reservoir and the well. Reliably predicting IPR under variable and complex circumstances presented by the diversity of wells and reservoirs is a serious challenge.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for predicting the inflow performance relationship (IPR) for an oil and gas well and a reservoir in an oil and gas field. The method includes obtaining field data from the oil and gas field and obtaining a set of operation parameters related to the oil and gas field. The method further includes determining, with a hybrid machine learning (ML) model including at least one ML model, a predicted IPR based on the field data and in view of the set of operation parameters. The method further includes adjusting, with a well controller, the set of operation parameters based on, at least, the predicted IPR.

Embodiments disclosed herein generally relate to a system including an oil and gas field, an oil and gas well and a reservoir, where the operation of the oil and gas field is defined, at least in part, by a set of operation parameters. The system further includes a plurality of field devices disposed throughout the oil and gas field, the plurality of field devices gathering field data, and a control system configured to adjust one or more field devices in the plurality of field devices. The system further includes a computer configured to obtain the field data from the oil and gas field and obtain the set of operation parameters for the oil and gas field. The computer is further configured to determine, with a hybrid machine learning (ML) model comprising at least one ML model, a predicted inflow performance relationship (IPR) based on the field data and in view of the set of operation parameters. The computer is further configured to adjust, automatically, the set of operation parameters based on, at least, the predicted IPR.

Embodiments disclosed herein generally related to a non-transitory computer-readable memory including computer-executable instructions stored thereon that, when executed on a processor, cause the processor to perform the following steps. The steps include obtaining field data from an oil and gas field including an oil and gas well and a reservoir, and obtaining a set of operation parameters related to the oil and gas field. The steps further include determining, with a hybrid machine learning (ML) model including at least one ML model, a predicted inflow performance relationship (IPR) based on the field data and in view of the set of operation parameters. The steps further include adjusting, automatically, the set of operation parameters based on, at least, the predicted IPR.

Embodiments disclosed herein generally relate to a machine learning (ML) framework for predicting inflow performance relationship (IPR) in complex reservoirs. One or more embodiments make use of a hybrid ML model that effectively integrates genetic programming (GP) and artificial neural networks (ANN). The GP element of the framework evolves an array of mathematical functions tailored to model the predicted flow rate from a reservoir to a well, taking into account a wide range of field data. The field data encompasses key aspects of the well, reservoir, and the fluids therein, covering both dynamic and static properties. Following the evolution of these mathematical functions, the ANN element processes the evolved functions in conjunction with the field data and a set of operation parameters related to the functioning of the oil and gas field. The ANN refines the IPR prediction, making it more precise and applicable to the current state of the field. In one or more embodiments, the framework includes and leverages a comprehensive array of field devices distributed throughout the oil and gas field for data collection. This setup ensures that all relevant parameters, including well data, reservoir data, and fluid data, are meticulously gathered and analyzed. Further, control systems of the oil and gas field (e.g., a well controller) are automatically adjusted based on the predictive outputs of the hybrid ML model, enabling responsive and efficient operational changes. Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 depicts a well environment in accordance with one or more embodiments.

FIG. 2 depicts a system in accordance with one or more embodiments.

FIG. 3 depicts a system in accordance with one or more embodiments.

FIG. 4 depicts a flowchart in accordance with one or more embodiments.

FIGS. 5A, 5B, 5C, and 5D depict tree diagrams in accordance with one or more embodiments.

FIG. 6 depicts a neural network in accordance with one or more embodiments.

FIG. 7 depicts a flowchart in accordance with one or more embodiments.

FIG. 8 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, an “oil or gas well,” may include any number of “oil or gas wells” without limitation.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

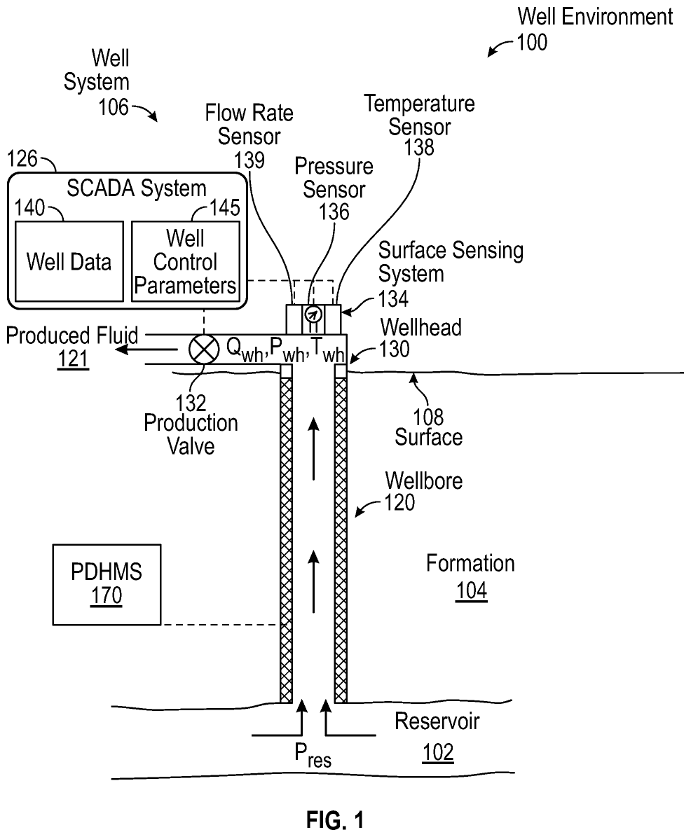

In the following description of FIGS. 1-8, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In general, embodiments of the disclosure include systems and methods for predicting inflow performance relationship (IPR) from well environments including at least one well and a reservoir accessed by the at least one well. For example, a well environment may include an oil and gas field including at least one hydrocarbon reservoir and one oil and gas well with access to the reservoir. The methods and systems of embodiments of the instant disclosure are applicable to reservoirs that are easily parameterized (i.e., accurately described by only a few parameters) to complex reservoirs with intricate or highly heterogeneous geological structure (e.g., multi-layered) that are not easily parameterized. In general cases, for simplicity, the material output of a production well is a produced fluid. The produced fluid may be multiphase and be composed of a variety of solid, liquid, and gaseous constituents. For example, the produced fluid may contain solid particulates like sand, mineral precipitates such as pipe scale, and corroded pipe, liquid such as water (referenced herein as “produced water”), hydrocarbons in both liquid (i.e., oil) and gas states (gaseous hydrocarbons may simply be referred to as “gas”), and other gases like carbon dioxide (CO₂) and hydrogen sulfide (H₂S). The methods and systems described herein are applicable for many types of produced fluids, including those characterized as single-phase or multi-phase.

IPR is defined as the flow rate or production rate of produced fluid as a function of the wellbore flowing pressure. Generally, IPR has been used extensively in the oil and gas (or petroleum) industry as an informative metric, and accordingly the language adopted in the instant disclosure will reflect the conventional terminology used in the oil and gas industry. Therefore, the term “reservoir” may be interchangeable with any multiphase (or single-phase) fluid-containing body associated with a subsurface formation, and a “production well” (“well system” or simply “well”) may refer to any type of well extracting fluid from a subsurface formation. However, methods and systems of the instant disclosure may also be applied to other types of wells, such as injection wells. Many types of wells (e.g., conventional oil wells) and their associated subsurface formations may be described by a particular IPR. Owing to the general applicability of IPR in relating key characteristics in wells and their associated subsurface formations, IPR is used in many applications, for example, reservoir management, well design, fluid production optimization, and well-reservoir modeling.

For a given well and associated reservoir, the IPR is sensitive to the physical characteristics and conditions of the well, the reservoir, and the fluid in the well and reservoir. In one or more embodiments, the IPR is predicted using a hybrid machine learning (ML) model, including at least one ML model, based on (or accepting as inputs) field data acquired from the well, reservoir, and fluid. In one or more embodiments, the hybrid ML model includes a plurality of individual ML models working in concert to determine the predicted IPR. However, in other embodiments, the hybrid ML model includes only one individual ML model that determines the predicted IPR. In sum, the hybrid ML model may include one or many ML models, without limitation, used to determine the predicted IPR, without departing from the scope of this disclosure In one or more embodiments, the hybrid ML model includes a first ML model that processes, at least, the field data using genetic programming techniques to determine a set of mathematical functions describing flow rate based on the field data. In one or more embodiments, the hybrid ML model includes a second ML model that further processes the field data alongside the mathematical functions determined by the first ML model to ultimately predict the IPR for a given well and reservoir. In one or more embodiments, the field data may include well data describing properties of the well (e.g., well diameter, wellbore length, gas-to-oil ratio, etc.), reservoir data describing properties of the reservoir (e.g., reservoir temperature, reservoir pressure, etc.), and fluid data describing properties of the fluid(s) in the reservoir and well (e.g., fluid density, viscosity, etc.). In one or more embodiments, the hybrid ML model may further be informed by a set of operation parameters that define configurable aspects of an oil and gas field. For example, the set of operation parameters may include well control parameters, the well control parameters defining the state of hardware governing fluid flow in the well system (e.g., a valve configured to be opened or closed, or partially closed) or adjusting pressure throughout, among other aspects of the well operation. Using the hybrid ML model to predict IPR, a command may be sent to update the set of operation parameters of the well to new values or states to achieve a particular goal, for example, to improve fluid production by the well.

FIG. 1 shows a schematic diagram in accordance with one or more embodiments. More specifically, FIG. 1 illustrates a well environment (100) that includes a hydrocarbon reservoir (“reservoir”) (102) located in a subsurface formation (“formation”) (104) and a well system (106). The formation (104) may include a porous formation that resides underground, beneath the Earth's surface (“surface”) (108). In the case of the well system (106) being a hydrocarbon well, the reservoir (102) may include a portion of the formation (104). The formation (104) and the reservoir (102) may include different layers (referred to as subterranean intervals or geological intervals) of rock having varying characteristics, such as varying degrees of permeability, porosity, capillary pressure, and resistivity. In other words, a subterranean interval is a layer of rock having approximately consistent permeability, porosity, capillary pressure, resistivity, and/or other characteristics. For example, the reservoir (102) may be an unconventional reservoir or tight reservoir in which fractured horizontal wells are used for hydrocarbon production. Generally, a “complex” reservoir may be any reservoir that exhibits physical characteristics or internal qualities which vary substantially on either spatial or temporal scales. In the case of the well system (106) being operated as a production well, the well system (106) may facilitate the extraction of hydrocarbons (or “hydrocarbon production,” or simply “production” when appropriate based on context) from the reservoir (102).

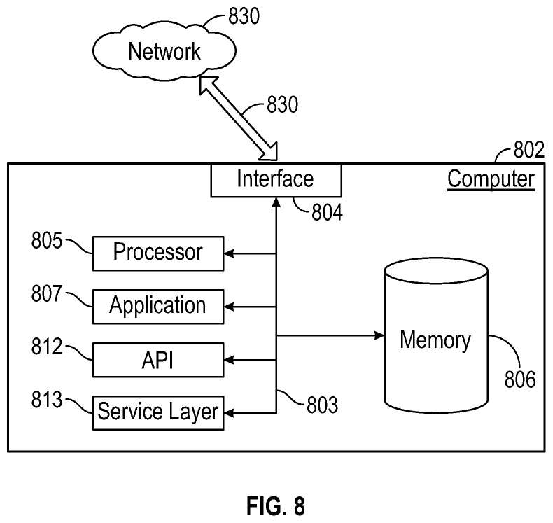

In some embodiments, the well system (106) includes a wellbore (120) and a well control system (e.g., Supervisory Control and Data Acquisition (SCADA) system (126)). The control system may control various operations of the well system (106), such as well production operations, well completion operations, well maintenance operations, and reservoir monitoring, assessment and development operations. In some embodiments, the control system includes a computer system that is the same as or similar to that of the computer system depicted in FIG. 8 with its accompanying description.

The wellbore (120) may include a bored hole that extends from the surface (108) into a target zone (i.e., a subterranean interval) of the formation (104), such as the reservoir (102). An upper end of the wellbore (120), terminating at or near the surface (108), may be referred to as the “up-hole” end of the wellbore (120), and a lower end of the wellbore, terminating in the formation (104), may be referred to as the “down-hole” end of the wellbore (120). The wellbore (120) may facilitate the circulation of drilling fluids during drilling operations, the flow the produced fluid (121) (e.g., hydrocarbons, water, etc.) from the subsurface to the surface (108) during production operations, the injection of substances (e.g., water) into the formation (104) or the reservoir (102) during injection operations, the placement of monitoring devices (e.g., logging tools) into the formation (104) or the reservoir (102) during monitoring operations (e.g., during in situ logging operations).

In some embodiments, a casing (not shown) is installed in the wellbore (120). For example, the wellbore (120) may have a cased portion and an uncased (or “open-hole”) portion. The cased portion may include a portion of the wellbore having casing (e.g., casing pipe and casing cement) disposed therein. The uncased portion may include a portion of the wellbore not having casing disposed therein. In embodiments having a casing, the casing defines a central passage that provides a conduit for the transport of tools and substances through the wellbore (120). For example, the central passage may provide a conduit for lowering logging tools into the wellbore (120), a conduit for the flow of production (121) (e.g., oil and gas) from the reservoir (102) to the surface (108), or a conduit for the flow of injection substances (e.g., water) from the surface (108) into the formation (104). In some embodiments, the well system (106) includes production tubing installed in the wellbore (120). The production tubing may provide a conduit for the transport of tools and substances through the wellbore (120). The production tubing may, for example, be disposed inside casing. In such an embodiment, the production tubing may provide a conduit for some or all of the produced fluid (121) (e.g., oil, gas, water) passing through the wellbore (120) and the casing.

In some embodiments, various control components and sensors are disposed down-hole along the wellbore (120). For example, in one or more embodiments, an inflow control valve (ICV) may disposed along the wellbore. An ICV is an active component usually installed during well completion. The ICV may partially or completely choke flow into a well. Generally, multiple ICVs may be installed along the reservoir section of a wellbore. Each ICV is separated from the next by a packer. Each ICV can be adjusted and controlled to alter flow within the well and, as the reservoir depletes, prevent unwanted fluids from entering the wellbore. In addition, the control components and sensors may further include a subsurface safety valve (SSSV). The SSSV is designed to close and completely stop flow in the event of an emergency. Generally, an SSSV is designed to close on failure. That is, the SSSV requires a signal to stay open and loss of the signal results in the closing of the valve. In one or more embodiments, a permanent downhole monitoring system (PDHMS) (170) is secured downhole. The PDHMS (170) consists of a plurality of sensors, gauges, and controllers to monitor subsurface flowing and shut-in pressures and temperatures. As such, a PDHMS (170) may indicate, in real-time, the state or operating condition of subsurface equipment and the fluid flow. In one or more embodiments, the PDHMS (170) may further measure and monitor temperature and pressure within the reservoir (102) as well as other properties not listed.

In some embodiments, the well system (106) includes a wellhead (130). The wellhead (130) may include a rigid structure installed at the “up-hole” end of the wellbore (120), at or near where the wellbore (120) terminates at the Earth's surface (108). The wellhead (130) may include structures (called “wellhead casing hanger” for casing and “tubing hanger” for production tubing) for supporting (or “hanging”) casing and production tubing extending into the wellbore (120). Produced fluid (121) may flow through the wellhead (130), after exiting the wellbore (120), including, for example, the casing and the production tubing. In some embodiments, the well system (106) includes flow regulating devices that are operable to control the flow of substances into and out of the wellbore (120). For example, the well system (106) may include one or more production valves (132) that are operable to control the flow of the produced fluid (121). For example, a production valve (132) may be fully opened to enable unrestricted flow of the produced fluid (121) from the wellbore (120), the production valve (132) may be partially opened to partially restrict (or “throttle”) the flow of the produced fluid (121) from the wellbore (120), and production valve (132) may be fully closed to fully restrict (or “block”) the flow of produced fluid (121) from the wellbore (120).

In some embodiments, the wellhead (130) includes a choke assembly. For example, the choke assembly may include hardware with functionality for opening and closing the fluid flow through pipes in the well system (106). Likewise, the choke assembly may include a pipe manifold that may lower the pressure of fluid traversing the wellhead. As such, the choke assembly may include a set of high pressure valves and at least two chokes. These chokes may be fixed or adjustable or a mix of both. Redundancy may be provided so that if one choke has to be taken out of service, the flow can be directed through another choke. In some embodiments, pressure valves and chokes are communicatively coupled to the well control system (e.g., SCADA system (126)).

Keeping with FIG. 1, in some embodiments, the well system (106) includes a surface sensing system (134). The surface sensing system (134) may include sensors for sensing characteristics of substances, including the produced fluid (121), passing through the wellbore (120) at various stages. The characteristics may include, for example, pressure, temperature and flow rate of produced fluid (121) flowing through the wellhead (130), or other conduits of the well system (106), after exiting the wellbore (120).

In some embodiments, the surface sensing system (134) includes a surface pressure sensor (136) operable to sense the pressure of the produced fluid (121) flowing through the well system (106) and its components after it exits the wellbore (120). The surface pressure sensor (136) may include, for example, a wellhead pressure sensor that senses a pressure of the produced fluid (121) flowing through or otherwise located in the wellhead (130). In some embodiments, the surface sensing system (134) includes a surface temperature sensor (138) operable to sense the temperature of the produced fluid (121) flowing through the well system (106), after it exits the wellbore (120). The surface temperature sensor (138) may include, for example, a wellhead temperature sensor that senses a temperature of the produced fluid (121) flowing through or otherwise located in the wellhead (130), referred to as “wellhead temperature” (T_{wh}). In some embodiments, the surface sensing system (134) includes a flow rate sensor (139) operable to sense the flow rate of the produced fluid (121) flowing through the well system (106), after it exits the wellbore (120). The flow rate sensor (139) may include hardware that senses a flow rate of the produced fluid (121) (Q_{wh}) passing through the wellhead (130). In one or more embodiments the flow rate sensor (139) is a multiphase flow meter (MPFM). The MPFM monitors the flow rate of the produced fluid (121) by constituent. That is, the MPFM may detect the instantaneous amount of gas, oil, and water. As such, the MPFM indicates percent water cut (% WC) and the gas-to-oil ratio (GOR). Additionally, the MPFM may measure pressure and fluid density. The MPFM may further include, or make use of, the surface pressure sensor (136) and the surface temperature sensor (138).

In accordance with one or more embodiments, during operation of the well system (106), the control system (e.g., SCADA system (126)) collects and records well data (140) for the well system (106). The well data (140) may include, for example, a record of measurements of wellhead pressure (P_{wh}) (e.g., including flowing wellhead pressure), wellhead temperature (T_{wh}) (e.g., including flowing wellhead temperature), wellhead volume flow rate (Q_{wh}) over some or all of the life of the well (106), and water cut data. The well data (140) may further include wellhead data regarding the choke assembly and data referring to the states of subsurface valve(s) (e.g., ICV), if any, and other sensor data collected and received by the PDHMS (170), including a record of measurements of reservoir properties like temperature and pressure.

In some embodiments, the measurements are recorded in real-time, and are available for review or use within seconds, minutes, or hours of the condition being sensed (e.g., the measurements are available within 1 hour of the condition being sensed). In such an embodiment, the wellhead data (140) may be referred to as “real-time” well data (140). Real-time well data (140) may enable an operator of the well (106) to assess a relatively current state of the well system (106), and make real-time decisions regarding development of the well system (106) and the reservoir (102), such as on-demand adjustments in regulation of the produced fluid (121) from the well.

The various valves, pressure gauges and transducers, sensors, and flow meters depicted of a well may be considered devices of an oil and gas field. As described, these devices may be disposed both above and below the surface of the Earth. These devices are used to monitor and control components and sub-processes of an oil and gas field. It is emphasized that the plurality of oil and gas field devices described in reference to FIG. 1 are non-exhaustive. Additional devices, such as electrical submersible pumps (ESPs) (not shown) may be present in an oil and gas field with their associated sensing and control capabilities. For example, an ESP may monitor the temperature and pressure of a fluid local to the ESP and may be controlled through adjustments to ESP speed or frequency.

The plurality of oil and gas field devices may be distributed, local to the sub-processes and associated components, global, connected, etc. The devices may be of various control types, such as a programmable logic controller (PLC) or a remote terminal unit (RTU). For example, a programmable logic controller (PLC) may control valve states, pipe pressures, warning alarms, and/or pressure releases throughout the oil and gas field. In particular, a programmable logic controller (PLC) may be a ruggedized computer system with functionality to withstand vibrations, extreme temperatures, wet conditions, and/or dusty conditions, for example, around a well system (106). With respect to an RTU, an RTU may include hardware and/or software, such as a microprocessor, that connects sensors and/or actuators using network connections to perform various processes in the automation system. As such, a distributed control system may include various autonomous controllers (such as remote terminal units) positioned at different locations throughout the oil and gas field to manage operations and monitor sub-processes. Likewise, a distributed control system may include no single centralized computer for managing control loops and other operations.

In accordance with one or more embodiments, and as depicted in FIG. 1, the well control system can be a supervisory control and data acquisition (SCADA) system (126). A SCADA system (126) is a control system that includes functionality for device monitoring, data collection, and issuing of device commands. The SCADA system (126) enables local control at an oil and gas field as well as remote control from a control room or operations center. To emphasize that the SCADA system (126) may monitor and control the various devices of an oil and gas field, dashed lines connecting some of the oil and gas field devices to the SCADA system (126) are shown in FIG. 1.

In review, and in accordance with one or more embodiments, a plurality of field devices are disposed throughout a well system (106). A field device may be disposed below the surface (108), e.g., a component of the PDHMS (170), or located above the surface (108) and considered part of the well surface sensing system (134). Field devices disposed below the surface may further measure properties or characteristics of the reservoir (102). Generally, field devices can measure or sense a property, control a state or process of the well system (106), or provide both sensory and control functionalities. For example, a state of a valve may include an indication of whether the valve is open or closed. In some instances, the state of a valve may be given by some percentage of openness (or closedness). As such, a field device, which may be the valve itself, can determine and transmit the state of the valve and therefore act as a sensor or sensory device. Further, a field device, which may be the valve itself, can alter or change the state of the valve by receiving a signal from the SCADA system (126). Sensed or measured properties of the well system (106) are stored and/or collected as well data (140) for the well, regardless if the sensed or measured property was determined by a field device of the PDHMS (170) or the well surface sensing system (134) or other device.

Operation of the well system (106) may be controlled or dictated through one or more well control parameters (145). The well control parameters (145) may represent and/or prescribe an operational state of the devices of the well system. Thus, in one or more embodiments, the well system (106) is controlled through a control system (e.g., SCADA system (126)) that determines and transmits a command signal to the field devices of the well system (106) according to the well control parameters (145).

In one or more embodiments, the well system (106) may be an injection well. The injection well injects, or places, a fluid into porous subsurface formations such as a reservoir. The injected fluid may be composed of brine, freshwater, steam, polymers, carbon dioxide, and other chemical agents. The injected fluid may be tailored to the subsurface formations and further account for the location of one or more production wells in an oil and gas field to displace and aid in the extraction of oil and gas. Accordingly, well control parameters (145) for an injection well may include the composition of the injection fluid and its volume flow rate into the subsurface. When an oil and gas field is composed of more than one injection well, the well control parameters (145) may further dictate a pattern injection strategy for the oil and gas field.

In one or more embodiments, the well system (106) may be a hydraulic fracturing well. In hydraulic fracturing, water, sand, and/or other chemicals may be injected into a well to break up underground bedrock and improve accessibility to oil and gas reserves. Again, the operation of a hydraulic fracturing well, as well as the composition of a fracturing fluid the processes driving its injection into the subsurface, are defined and controlled by well control parameters (145) for the hydraulic fracturing well.

Thus, regardless of the type of well system (106), the operation of the well system (106) and specification of materials and processes associated with the operation well system (106) are encompassed by the well control parameters (145) for the well system (106). The well control parameters (145) are both monitored and controlled by a control system (e.g., SCADA system (126)). The control system need not be proximate the well system (106) but may be located at a remote location relative to the well system (106).

Oil and gas field devices, like those shown in FIG. 1 (and others not shown), monitor and govern the behavior of the components and sub-processes of the oil and gas field. Therefore, the productivity of the oil and gas field (and the behavior of a well, generally) is directly affected, and may be altered, by the devices. Generally, complex interactions between oil and gas field components and sub-processes exist such that configuring field devices for optimal production is a difficult and laborious task. Further, the state and behavior of oil and gas fields is transient over the lifetime of the constituent wells requiring continual changes to the field devices to enhance production or enact other goals. One informative metric that may be useful in determining the changes to field devices to enact enhanced production, among other goals, is the well and reservoir inflow performance relationship (IPR). As previously defined, the IPR generally describes the flow rate or production rate of produced fluid as a function of the wellbore flowing pressure. For a given well and associated reservoir, the IPR is sensitive to the physical characteristics and conditions of the well, the reservoir, the fluid in the well and reservoir, and possibly the configurable aspects of the well defining the operation of the well, such as the well control parameters (145). Thus, predicting the IPR for a given well and reservoir, the various components of which may exhibit transient characteristics, is also a challenge. The challenge is further exacerbated when applied to complex reservoirs which exhibit physical characteristics or internal qualities which vary substantially on spatial and possibly temporal scales in their geology and geometry, and that are overall not easily characterized by conventional methods.

In one aspect, embodiments disclosed herein relate to a system for predicting or determining the IPR for a given well and reservoir. The IPR is determined by a hybrid machine learning model including at least one machine learning model taking into consideration the current state of the oil and gas field as monitored by the plurality of oil and gas field devices, and further in view of the configurable aspects of the well system as defined by a set of operation parameters. In accordance with one or more embodiments, the predicted IPR is further used by a control system, such as the SCADA system (126), to issue or transmit a digital or electronic signal or command to automatically, and in real-time, update or adjust the set of operation parameters to alter the behavior or state of the well according to a user-defined goal. As the IPR describes how the flow rate changes with respect to changes in wellbore flowing pressure, the operation parameters may be modified in an attempt to lower the wellbore flowing pressure to increase flow rate. For example, the predicted IPR may be used by a control system, such as the SCADA system (126), to automatically transmit a signal to modify the states of surface and subsurface valves to alter the production state of a well by lowering wellbore flowing pressure for improved fluid production.

In accordance with one or more embodiments, field data from the well environment are processed with a machine learning model to determine or predict the IPR of the associated well and reservoir. Machine learning, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning (ML), will be adopted herein, however, one skilled in the art will recognize that the concepts and methods detailed hereafter are not limited by this choice of nomenclature.

Machine learning (ML) model types may include, but are not limited to, neural networks, random forests, generalized linear models, and Bayesian regression. Further, as defined herein, ML may include algorithmic search methods and optimization methods such as a line search or the genetic algorithm. ML model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. The selection of hyperparameters surrounding a model is referred to as selecting the model “architecture.” Generally, multiple model types and associated hyperparameters are tested and the model type and hyperparameters that yield the greatest predictive performance on a hold-out set of data is selected.

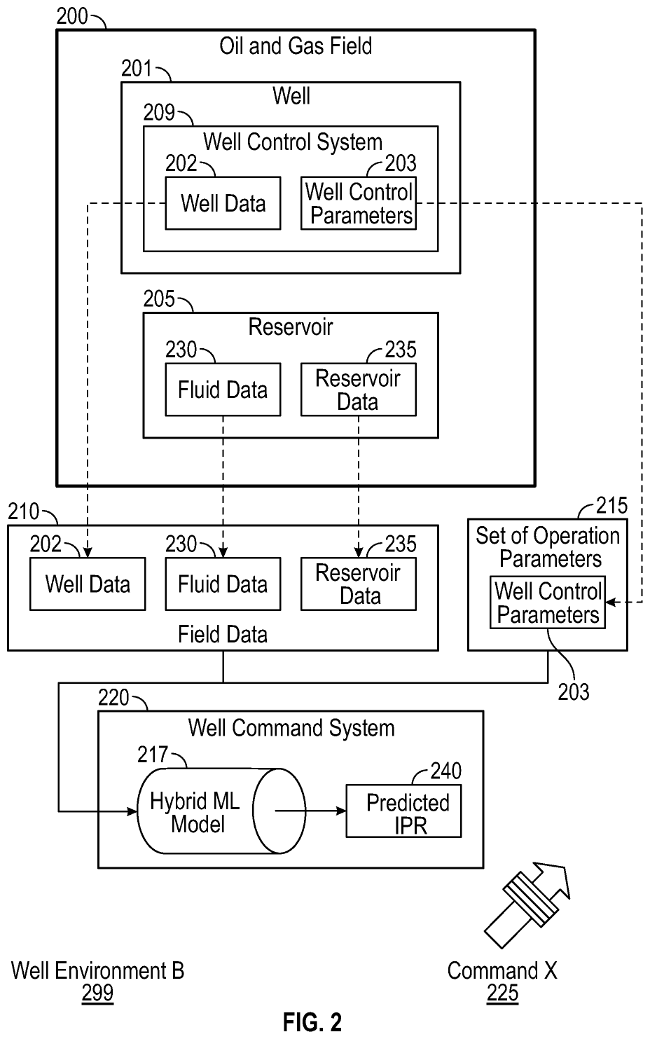

As noted, the objective of the ML model is to determine the IPR for a given well and reservoir. In accordance with one or more embodiments, FIG. 2 depicts the interactions between the hybrid ML model, field data, and the set of operation parameters in the context of a well environment.

FIG. 2 depicts a schematic diagram representing one possible embodiment of a well environment (e.g., well environment B (299)) as described in FIG. 1, meaning the structures need not be identical though similar structural elements are components may be included. Further, for concision and consistency, like-named elements may have names repeated to serve analogous or identical roles. The well environment (e.g., well environment B (299)) includes an oil and gas field (200), where the oil and gas field (200) further includes a well (201) and a reservoir (205). The well includes a well control system (209), and the well control system (209) has associated with itself well data (202) and well control parameters (203). The reservoir (205) has associated with itself fluid data (230) corresponding to fluid within the reservoir (205) and reservoir data (235).

In one or more embodiments, the well control system (209) controls various operations of the well (201), such as well production operations, well completion operations, well maintenance operations, and monitoring, assessment and development operations. In some embodiments, the control system includes a computer system that is the same as or similar to that of computer system depicted in FIG. 8 with its accompanying description. Regarding the well data (202) corresponding to the well (201) and associated well control system (209), the well data (202) describes both dynamic and static properties of the well (201) in accordance with one or more embodiments. For example, the well data (202) may include measurements of temperature, pressure, percent water cut (% WC), and gas-to-oil ratio (GOR) from one or more field devices disposed throughout the well. The well data (202) may further include frequency, speed, pressure, and temperature measurements from one or more electrical submersible pumps (ESPs), pressure readings from one or more pressure transducers, temperature measurements from one or more temperature sensors, and valve states. In addition, the well data (202) may include measurements of the well geometry, such as the wellbore radius, wellbore length (for horizontal wells), wellbore depth (for vertical wells) or other physical attributes such as the well completion skin factor. The well data (202) may further include subsurface measurements from devices disposed within the well, such as wellbore flowing pressure. In one or more embodiments, the well data (202) further includes the production history and injection history of the wells of the oil and gas field, respectively, if present.

Regarding the reservoir data (235) corresponding to the reservoir (205), the reservoir data (235) describes both dynamic and static properties of the reservoir (205) in accordance with one or more embodiments. For example, the reservoir data (235) may include subsurface measurements from devices disposed within or proximate to the reservoir, such as temperature and pressure of the reservoir. The reservoir data (235) may further include measurements of reservoir permeability, net pay thickness, porosity and other geological information. In addition, the reservoir data (235) may include measurements of the reservoir geometry, such as the reservoir radius, reservoir depth and spatial extent.

Regarding the fluid data (230) corresponding to the reservoir (205), the fluid data describes both dynamic and static properties of the fluid within the reservoir (205) in accordance with one or more embodiments. Note that the fluid that is described by the fluid data (230) need not be limited exclusively to the reservoir. In other words, the fluid data (230) may also describe fluid that is in the well, completion fluid, injected fluid, etc. The fluid may be multiphase and be composed of a variety of solid, liquid, and gaseous constituents. For example, the fluid may contain solid particulates like sand, mineral precipitates such as pipe scale, and corroded pipe, liquid such as water, hydrocarbons in both liquid (i.e., oil) and gas states, and other gases like carbon dioxide (CO₂) and hydrogen sulfide (H₂S). The fluid data (230) may include measurements of viscosity, density, temperature, water saturation (%), in addition to measurements indicating the different constituents present in the fluid and their ratios (e.g., volume or mass ratio) with respect to each other. The fluid data (230) may also describe the properties of various constituents within the reservoir (if a multiphase fluid) or a single fluid.

In accordance with one or more embodiments, the well control system (209) is defined by well control parameters (203). The well control parameters (203) define and assign states to devices disposed within the well (201), which may include valves, such as production valve and inflow control valves near the surface, controllers of a permanent downhole monitoring system and associated devices, one or more tools for logging, one or more choke assemblies, and one or more electrical submersible pumps.

As seen, data from the components of the oil and gas field (200) within the well environment (e.g., well environment B (299)) are collected from the plurality of devices of the oil and gas field and are stored as field data (210). That is, the field data (210) contains all data gathered and measured from the various devices disposed within the well (201) and at the surface of the well (201) and within or proximate to the reservoir (205). Similarly, configurable aspects, features, elements, or structures of the well environment (e.g., well environment B (299)) may be collectively stored as a set of operation parameters (215). In one or more embodiments, the set of operations parameters (215) includes the well control parameters (203) of the well control system (209) and well (201). One with ordinary skill in the art will appreciate that additional field devices may be employed in an oil and gas field and that additional associated field data may be collected without departing from the scope of this disclosure. Similarly, additional configurable devices beyond those listed may be included within the well environment leading to additional parameters beyond those listed in the set of operation parameters, without limitation. For example, in one or more embodiments, the set of operation parameters may further include drilling parameters defining the operation of a drilling system.

Continuing with FIG. 2, in accordance with one or more embodiments, the field data (210) and set of operation parameters (215) are processed by a hybrid ML model (217). In one or more embodiments, the result of the hybrid ML model (217) is a prediction of the inflow performance relationship (“predicted IPR” (240)) for the well environment (e.g., well environment B (299)). As previously defined, the IPR describes flow rate as a function of the wellbore flowing pressure. IPR, however, is sensitive to the physical characteristics and conditions of the well, the reservoir, and the fluid in the well and reservoir. Thus, in accordance with one or more embodiments, the hybrid ML model (217) predicts or determines the IPR (240) based on, or accepting as inputs, the field data (210) and in view of the well control parameters (203). Accordingly, the IPR may be generally thought of as a multivariable (or multidimensional) function, though in some embodiments the IPR is a function of only one variable (e.g., the wellbore flowing pressure).

IPR may be presented in a variety of forms. For example, IPR may be given in the form of a continuous analytic function such as a polynomial, rational function, a transcendental function, and a piecewise function, or any combination therein. IPR may further be represented by a differential equation or partial differential equation such that the family of solutions to the partial differential equation may each describe the IPR, the exact solution being discernible with a set of suitable boundary conditions and initial conditions. In one or more embodiments, the predicted IPR (240) is not represented by an explicit mathematical function but is numerically approximated. Further, in one or more embodiments, the predicted IPR (240) is a single value representing the flow rate calculated according to a given set of conditions, e.g., according to field data (210) including well data (202) such as the wellbore length, fluid data (230) such as the fluid viscosity, and reservoir data (235) such as the reservoir pressure, in view of the operational state defined by set of operation parameters (215). In other words, in one or more embodiments, the predicted IPR (240) is just the flow rate (i.e., a single value) according to a set of conditions represented by the field data (210) and set of operation parameters (215). In practice, however, the hybrid ML model (217) will have extracted patterns or insights from (or “learned” the relationships between) various members of the field data (210) and the set of operation parameters (215), such that the hybrid ML model (217) may determine a different predicted IPR (240) under different conditions. In this way, it would be possible to construct a “classical” IPR curve presenting flow rates as a function of one or more variables using the predicted IPR (240), or to simply consider flow rates according to the values of one or more variables.

In one or more embodiments, the field data (210) and set of operation parameters (215), are continuously monitored by the plurality of devices disposed throughout the well environment (e.g., well environment B (299)). Accordingly, the predicted IPR (240) may be determined at any given moment in time, or across a predefined interval of time (e.g., the predicted IPR (240) may be determined every thirty minutes or every fifteen minutes).

In accordance with one or more embodiments, the field data and the set of operation parameters may be pre-processed before being processed by the hybrid ML model (217). Pre-processing may include activities such as numericalization, filtering and/or smoothing of the data, scaling (e.g., normalization) of the data, feature selection, outlier removal (e.g., z-outlier filtering) and feature engineering. Feature selection includes identifying and selecting a subset of field data with the greatest discriminative power with respect to predicting the hydrocarbon production and lithium extraction. For example, in one embodiment, discriminative power may be quantified by calculating the strength of correlation between elements of the field data and the predicted IPR (240). Consequently, in some embodiments, not all of the field data need be passed to the ML model. Feature engineering encompasses combining, or processing, various field data to create derived quantities. The derived quantities can be processed by the hybrid ML model (217). For example, the field data may be processed by one or more “basis” functions such as a polynomial basis function or a radial basis function. In some embodiments, the field data is passed to the hybrid ML model (217) without pre-processing. Many additional pre-processing techniques exist such that one with ordinary skill in the art would not interpret those listed here as a limitation on the present disclosure.

In accordance with one or more embodiments, the predicted IPR (240) is transmitted automatically and in real-time over a distributed network or through a physical mechanism for data transfer such as fiber optic cables via a well command system (220). The well command system (220) may be a controller similar to those employed by the well, such as an RTU or PLC. The well command system (220) may further include a computer that is the same as or similar to that of computer system depicted in FIG. 8 with its accompanying description. In one or more embodiments, the well command system (220) need not be physically associated with the well (201). In one or more embodiments, the well command system (220) may be physically proximate to the well (201). Further, the well command system (220) need not be its own structure. For example, the well command system (220) may be included by the well control system (209). According to the predicted IPR (240), the well command system (220) transmits a signal or command across the well environment system (e.g., well environment B (299)) to update one or more parameter values, the one or more parameters belonging to the set of operation parameters (215) defining the operation of configurable devices disposed throughout well environment (e.g., well environment B (299)). The command to update or modify the state of the well environment (e.g., well environment B (299)) is represented by Command X (225).

As previously described, owing to the general applicability of IPR in relating key characteristics in wells and their associated subsurface formations, IPR is used in many applications. For example, IPR is used in reservoir management, well design, fluid production optimization, and well-reservoir modeling. As such, the Command X (225) to update the set of operation parameters (215) may be a command to alter the well control parameters (203) in accordance with a well-lifting operation, such as opening one or more inflow control valves to limit or further enable fluid flow between the reservoir and well. The Command X (225) alternatively may be a command to modify the state of one or more choke assemblies to lower the pressure of fluid traversing the wellhead. These operations may be carried out as steps to improve fluid production, fluid injection, and well maintenance, among other operations not listed.

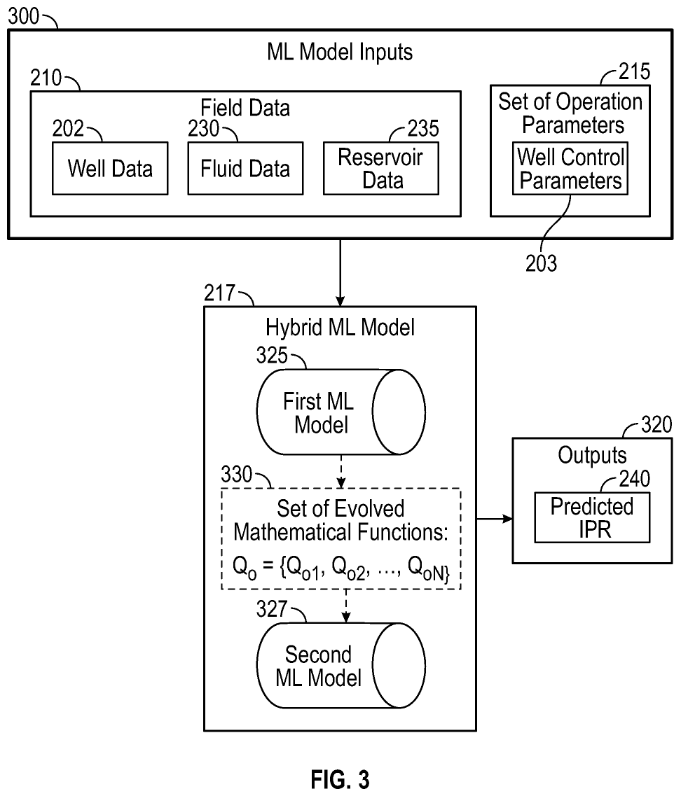

FIG. 3 depicts the use of the hybrid ML model (217) to process inputs (300) to predict outputs (320). The hybrid ML model (217) includes at least one ML model. In the embodiment depicted in FIG. 3, the ML model inputs (300) include the field data (210) and the set of operation parameters (215). The field data may include well data (202), fluid data (230), and reservoir data (235), while the set of operation parameters (215) may include well control parameters (203). The well data (202) may include measurements of the well such as its geometric dimensions and data gathered by devices disposed at the surface and downhole in the well such as wellbore flowing pressure. The fluid data (230) may include measurements of the fluid density and viscosity, and the fluid data (230) may further include measurements of the properties of multiple fluids (if present). The reservoir data (235) may include measurements of the reservoir such as its geometric dimensions and data gathered by devices disposed proximate or within the reservoir measuring reservoir pressure and reservoir temperature. The well control parameters (203) define the operation of the well control system, and thus may define the state of one or more inflow and production valves or other configurable device within the well affecting its operation. As a result of processing the inputs (300), the hybrid ML model (217) determines the output (320), which in this case is predicted IPR (240) for the well and reservoir, in accordance with one or more embodiments.

The hybrid ML model (217), including at least one ML model, may be of any ML model type known in the art. In some embodiments, multiple ML model types and/or architectures may be used. Generally, the ML model type and architecture with the greatest performance on a set of hold-out data is selected. Greater detail surrounding the training procedure for an ML model will be provided below in the context of a neural network. However, generally, training an ML model involves processing data to develop a functional relationship between elements of the data. The result of the training procedure is a trained ML model. The trained ML model may be described as a function relating the inputs (300) and the outputs (320). That is, the ML model may be mathematically represented as outputs=ƒ(inputs), such that given an input (300) the ML model may produce an output (320).

In one or more embodiments, the hybrid ML (217) model includes a plurality of individual ML models working in concert to determine the predicted IPR (240). However, in other embodiments, the hybrid ML (217) model includes only one individual ML model that determines the predicted IPR (240). In sum, the hybrid ML model (217) may include one or many ML models, without limitation, used to determine the predicted IPR (240), without departing from the scope of this disclosure.

In one or more embodiments, the hybrid ML model (217) includes a first ML model (325). The first ML model (325) may be of any ML model type known in the art, such as an artificial neural network, a decision tree (or ensemble of decision trees such as a random forest or gradient boosted trees), a support vector machine, or another algorithm using Gaussian processing techniques or evolutionary computation, among others not listed.

In accordance with one or more embodiments, the first ML model (325) uses evolutionary computation techniques, specifically genetic programming, to evolve a plurality of mathematical functions relating flow rate to the conditions of the well, reservoir, and fluid, i.e., to the ML model inputs (300). Evolutionary computation refers to a collection of optimization algorithms loosely based on, or inspired by, the principles of biological evolution. One example of such an optimization algorithm is the genetic algorithm. A genetic algorithm for optimizing model parameters involves generating a population of individuals, where each individual represents or encodes one possible model state as defined by one or more parameters and its assigned value. In this context, each parameter under optimization may be considered a “gene” (note that in some instances, a gene may be composed of more than one parameter). Next, individuals are updated, or “evolved,” with operations designed to mimic, in a simple manner, aspects of natural selection (i.e., “evolving” the individuals, allowing the individuals to “mutate” or “reproduce”) in order to obtain an improved (or a “more fit”) functional representation of observed data by the model. Individuals with lower “fitness” may be discarded, and the process iterates until finally a stopping condition is reached. Genetic programming may be thought of as a particular implementation of a genetic algorithm, however, genetic programming uses genetic algorithms to evolve a population of individuals where the individuals are themselves computer programs or functions and their genes include mathematical operators. Further detail regarding the implementation of genetic programming is given below, in accordance with one or more embodiments.

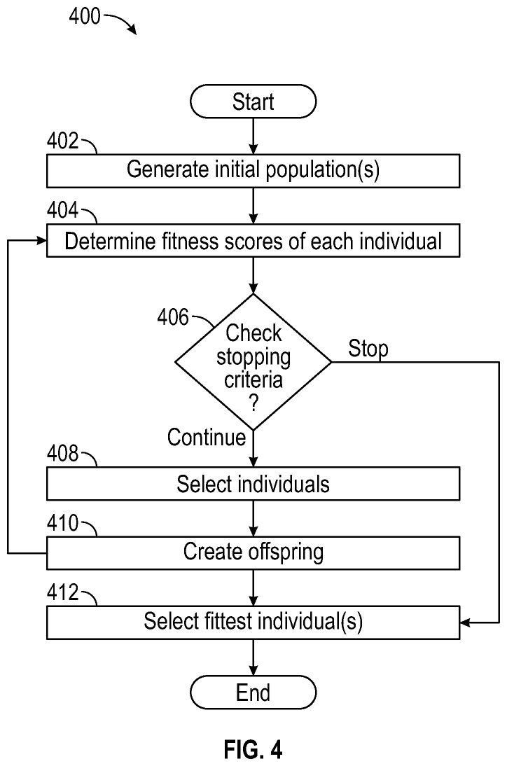

The implementation of genetic programming by the first ML model (325) of the hybrid ML model (217), according to one or more embodiments, may be better understood through illustration of a common genetic algorithm. An overview of the typical steps used in a genetic algorithm (GA) is provided in FIG. 4. The genetic algorithm (400) begins by generating an initial population or multiple populations (402). A population consists of one or more “individuals.” In the context of the genetic algorithm (400), an individual is a single representation, or encoding, of the function parameters over which optimization is to occur. However, as previously described above, in genetic programming, the individuals themselves are computer programs or functions. In the case of predicting an inflow performance relationship (IPR) for a given well and reservoir, the individuals are mathematical expressions predicting flow rate from the reservoir into the well. Flow rate is commonly represented by Qₒ, where the subscript o commonly used to denote oil (although the fluid may be multiphase). The flow rate is sensitive to the conditions of the well, reservoir, and flowing fluid. Each expression (individual) incorporates one or more parameters represented by the ML model inputs (300). Recall that the ML model inputs (300) include field data (210) and the set of operation parameters (215). Accordingly, one individual mathematical expression relates flow rate to some subset and combination of field data and some subset and combination of parameters from the set of operation parameters (215). Note that individuals may begin simply and consider only small subspaces of the total parameter space, or they may begin as high-order multivariate expressions of different kinds. The initiation of individuals is defined by the user, and different initiation routines may be considered. Though the individuals may be internally represented only as expressions, the individuals may be considered functions as they relate input variables (300) to an output (320), in this case, oil flow rates.

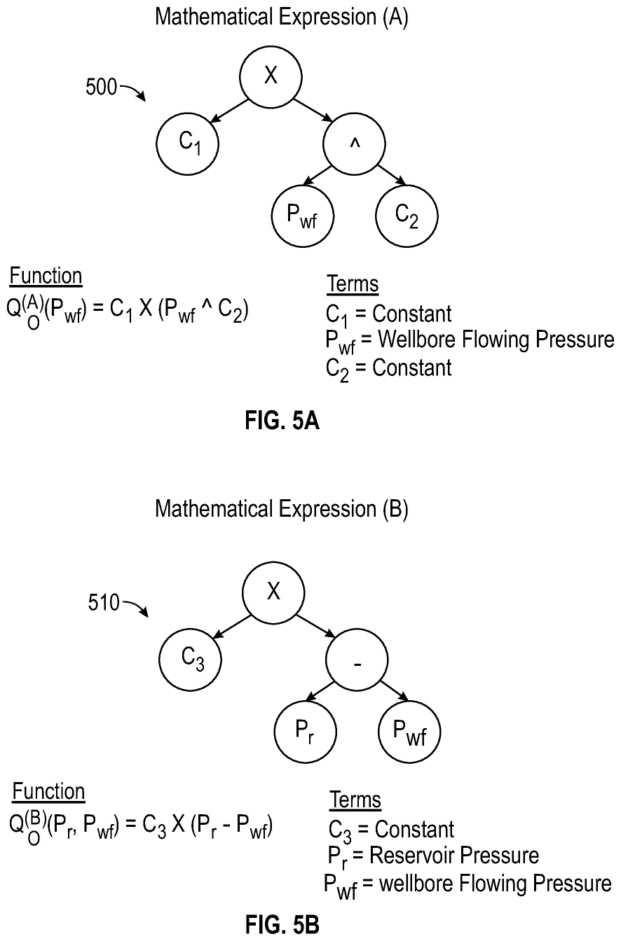

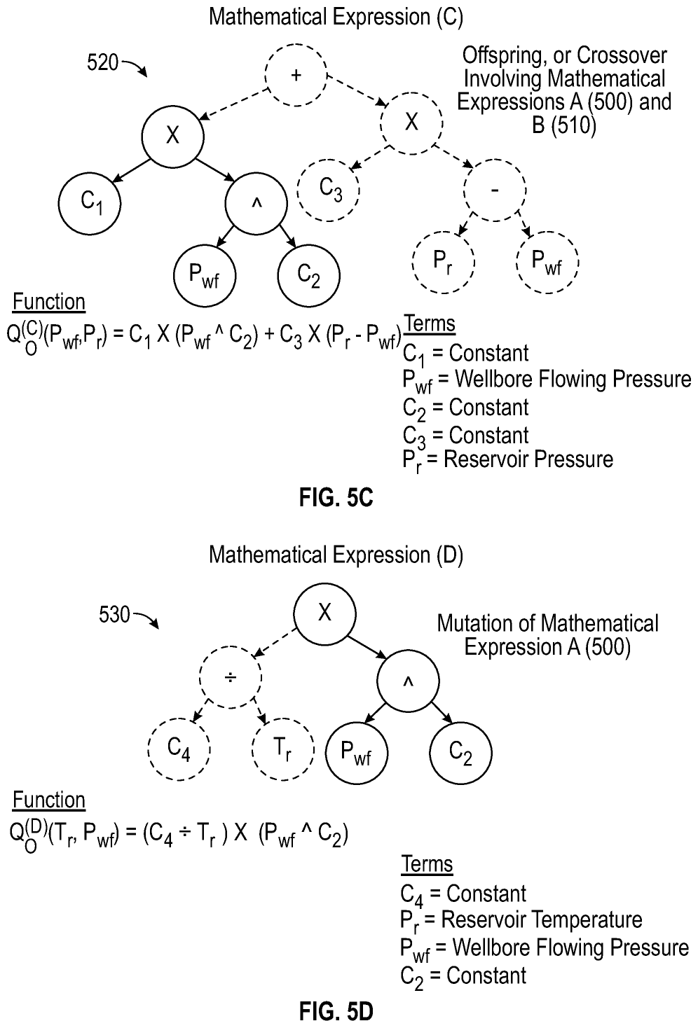

In genetic programming involving mathematical expressions, individuals are typically represented as “tree” structures, where “nodes” correspond to mathematical operators and “leaves” represent inputs and constants. FIG. 5A depicts an example of one function describing flow rate as encoded by a tree structure representation of its expression. An expression, mathematical expression A (500), is shown according to its tree structure. The function corresponding to mathematical expression A (500) may be written Qₒ^{(A)}=c₁×(P_{wf}\hat{ }c₂) where Qₒ^{(A)} is the oil flow rate, with the subscript o specifying “oil” (though the oil may be multiphase) and the superscript (A) indicating that this is the mathematical expression “A” (where the parenthesis in the superscript are to distinguish it from an exponent), P_{wf} is the wellbore flowing pressure, and c₁ and c₂ are constants. Further, “X” is the mathematical operator for multiplication, and “A” is the mathematical operator for exponentiation. In some cases, the oil flow rate returned by mathematical expression A (500) can be written as Qₒ^{(A)} (P_{wf}) to emphasize that this expression is a function of the wellbore flowing pressure P_{wf}. In this example, P_{wf} may be provided by the field data (210) as a measurement recorded as well data (202). Mathematical expression A (500) is an example of an individual in the context of the genetic programming used by the first ML model (325) of the hybrid ML model (217), in accordance with one or more embodiments. A second example of a function describing flow rate as encoded by a tree structure representation of its expression is provided in FIG. 5B. This second example is referred to as mathematical expression B (510). The function corresponding to mathematical expression B (510) may be written Qₒ^{(B)}=c₃×(Pᵣ−P_{wf}) with the superscript (B) indicating that this is mathematical expression “B,” Pᵣ is the reservoir pressure, and c₃ is a constant, and “−” is the mathematical operator for subtraction. In some cases, the oil flow rate returned by mathematical function B (510) can be written Qₒ^{(B)} (Pᵣ, P_{wf}) to emphasize that this expression is a function of the reservoir pressure Pᵣ and the wellbore flowing pressure P_{wf}. In this example, Pᵣ may be provided by the field data (210) as a measurement recorded as reservoir data (235).

Returning to FIG. 4, the construction of each individual must be allowed by the “environmental” constraints. For example, the genes of each mathematical expression can only correspond to variables present in the ML model inputs (300). The number of individuals in a population, and the method of initially generating individuals, are hyperparameters chosen by the user. When multiple populations are used, commonly referred to as an “island” scheme, the populations need not be initialized using the same set of hyperparameters. Once a population(s) has been generated (402), the “fitness” of every individual in the population(s) is evaluated (404). For example, in the context of the first ML model (325) included by the hybrid ML model (217) described in FIG. 3, each individual describes one possible functional relation between the ML model inputs (300) and a predicted flow rate from the reservoir into the well. Accordingly, individuals are considered “more fit” when the predicted flow rate more closely matches a measured flow rate. The difference between the predicted flow rate and measured flow rate is measured by a so-called “loss function” (although other names for this comparison function such as “error function,” “misfit function,” and “cost function” are commonly employed). The measured flow rate, a collection of flow rates corresponding to different conditions may itself be included by the field data (210) for the well environment. Alternatively, historical data from substantially similar or analogous reservoirs and wells including the parameters and data of interest (i.e., those included by ML model inputs (300)) may be used alongside the corresponding measured flow rates.

Next, a stopping criterion is checked (406). Many stopping criteria exist, including, but not limited to, the number of iterations the genetic algorithm has run, the maximum or minimum fitness score achieved by an individual, the relative change in fitness scores between iterations, and the similarity of individuals in a population, or combinations of these criteria. If the algorithm is to stop, typically, the most fit individual(s) seen during the genetic algorithm process is selected (412) and the algorithm terminates. Likewise, if the genetic algorithm continues, one or more individuals from the population(s) are selected (408). This selection may be done by simply selecting the portion of the population with the highest fitness scores, or through a tournament process, or other selection mechanism.

Once individuals have been selected (408), the individuals may be propagated through without alteration, removed, or altered through so-called crossover, mutation, and differential evolution methods to create “offspring” (410). An example of an individual (i.e., expression or function) created by crossover, or an offspring of two individuals, is presented in FIG. 5C. This third example is referred to as mathematical expression C (520). The function corresponding to mathematical expression C (520) may be written Qₒ^{(C)}=c₁×(P_{wf}\hat{ }c₂)+c₃×(Pᵣ−P_{wf}), where Q (is the oil flow rate with the superscript (C) indicating that this is mathematical expression “C,” and the remaining terms are those previously included by expressions A (500) and B (510) previously depicted in FIGS. 5A and 5B. In the example provided by mathematical expression C (520), the mathematical operator for addition “+” has been used to create the offspring from expression A (500) and expression B (510). In some cases, the oil flow rate returned by mathematical function C (520) can be written Qₒ^{(C)} (P_{wf}, Pᵣ) to emphasize that this expression is a function of the reservoir pressure Pᵣ and the wellbore flowing pressure P_{wf}. In FIG. 5C, the components of mathematical expression C (520) originating from mathematical expression A (500) are shown with solid lines while the components of mathematical expression C (520) originating from mathematical expression B (510) are shown with dashed lines.

An example of an individual (i.e., expression or function) created by mutation is presented in FIG. 5D. This fourth example is referred to as mathematical expression D (530). Mathematical expression D (530) is a mutation of mathematical expression A (400). The element of mathematical expression A (400) which was previously represented by the leaf “c₁” (a constant) has been replaced by a new element shown with dashed lines. The function corresponding to mathematical expression D (530) may be written Qₒ^{(D)}=(c₄+Tᵣ)×(P_{wf}\hat{ }c₂) where Q (D) is the oil flow rate with the superscript (D) indicating that this is mathematical expression “D,” Tᵣ is the reservoir temperature, c₄ is a constant, “=” is the mathematical operator for division, and the other operators and terms have been previously presented in mathematical expression A (500). In some cases, the oil flow rate returned by mathematical function D (530) can be written Qₒ^{(D)} (Tᵣ, P_{wf}) to emphasize that this expression is a function of the reservoir temperature Tᵣ and wellbore flowing pressure P_{wf}. In this example, Tᵣ may be provided by the field data (210) as a measurement recorded as reservoir data (235).

The offspring, including both those created by crossover and mutation are themselves individuals; that is, new representations of mathematical expressions describing flow rate. It is noted that many evolutionary methods exist to create offspring and the preceding list is not all-inclusive and should be considered non-limiting. The offspring are then evaluated for fitness (404) and the process is repeated until the genetic algorithm stopping criterion is met.

Again, the description of the genetic algorithm (GA) provided in FIG. 4 is generalized and one skilled in the art will appreciate that many modifications can be made, and are regularly made, to the genetic algorithm (GA) without departing from its intended scope. For example, an enhanced genetic algorithm (eGA) is developed by including additional features such as: enforcing deliberately diverse initial populations; using heterogenous hyperparameters for each population; dynamically updating or scheduling changes to the selection process and offspring creation process; using a unidirectional migration policy between populations; adding additional checks, such as a premature convergence check; using a self-adaptive differential evolution method; performing a localized exhaustive search in regions of stagnation or saturation.

Returning to FIG. 3, in one or more embodiments, the output of the first ML model (325) is a set of evolved mathematical functions (330). Each individual function in the set of evolved mathematical functions (330) is unique and describes flow rate from the reservoir into the well according to one or more variables, the variables belonging to the ML model inputs (300). In one or more embodiments, the set of evolved mathematical functions (330) include functions of one or more variables, the variables belonging to measurements contained in field data (210) or parameters belonging to the set of operation parameters (215). The functions in the set of evolved mathematical functions (330) are those that have been obtained through the genetic programming techniques employed by first ML model (325), in accordance with one or more embodiments. The set of evolved mathematical functions (330) includes N individual mathematical functions where N≥1.

In one or more embodiments, the hybrid ML model (217) includes a second ML model (327). The second ML model (327) may be of any ML model type known in the art, such as an artificial neural network, a decision tree (or ensemble of decision trees such as a random forest or gradient boosted trees), a support vector machine, or another algorithm using Gaussian processing techniques or evolutionary computation, among others not listed. In one or more embodiments, the second ML model (327) is an artificial neural network (ANN). Put simply, an ANN is a machine learning model that uses supervised learning to predict one or more outputs from a set of inputs in a framework inspired by the neural networks of animal brains. In the context of a hybrid ML model (217) used to predict IPR (240), the inputs to the second ML model (327), which in one or more embodiments is an ANN, may be the set of evolved mathematical functions (330) provided by the first ML model (325). The second ML model (327) may further be informed by the ML model inputs (300), either directly or indirectly. In one or more embodiments, the second ML model (327) is directly informed by the ML model inputs (300) alongside the set of evolved mathematical functions (330). That is, both the set of evolved mathematical functions (330) and the ML model inputs (300) are direct inputs to the second ML model (327). In alternate embodiments, the only direct input to the second ML model (327) is the set of evolved mathematical functions (330), but because each function in the set of evolved mathematical functions (330) is itself a function of one or more variables contained by the ML model inputs (300), the second ML model (327) may be said to be indirectly informed by the ML model inputs (300).

A more detailed explanation of the second ML model (327) belonging to the hybrid ML model (217) is given below, in accordance with one or more embodiments where the second ML model (327) is an artificial neural network.

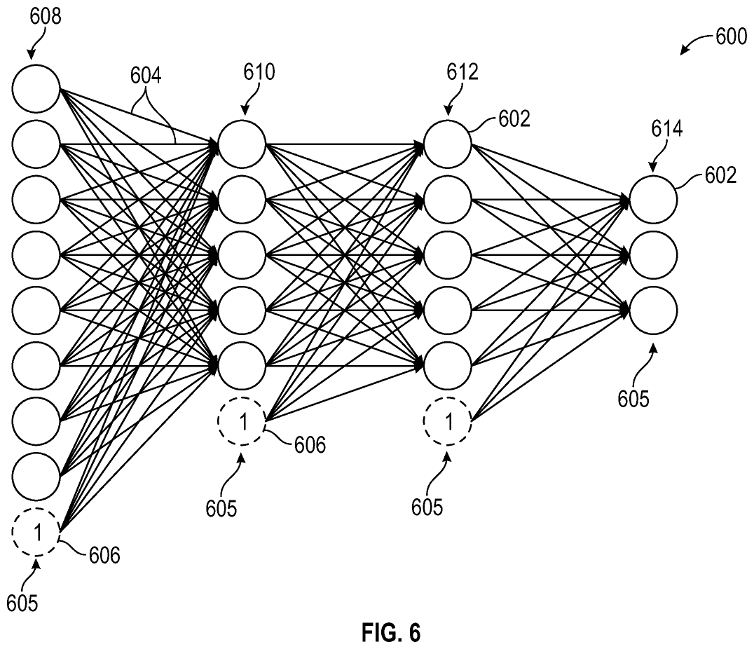

In accordance with one or more embodiments, one or more of the members of the hybrid ML model (217) discussed herein, such as the second ML model (327), may be an artificial neural network (“neural network”). A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer.” Any intermediate layer (610, 612) is usually described as a “hidden layer”. A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters.” While training a neural network (600), numerical values are assigned to each edge (604). Additionally, every node (602) is associated with a numerical variable and an activation function. Activation functions are not limited to any functional class, but traditionally follow the form:

$$A = f ( {\sum }_{i ∈ ( incoming )} [ {( node value )}_{i} {( edge value )}_{i} ] ) , \qquad ( 3 )$$

where i is an index that spans the set of “incoming” nodes (602) and edges (604) and f is a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max (0, x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (606), displayed in FIG. F with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Recall, that a given data set will be composed of inputs and associated target(s), where the target(s) represent the “ground truth,” or the otherwise desired output. In accordance with one or more embodiments, the input of the neural network is the set of evolved mathematical functions (330) and the target is the IPR of the well and reservoir. In one or more embodiments, the input of the neural network is both the set of evolved mathematical functions (330) and the ML model inputs (300), the ML model inputs (300) including field data (210) and the set of operation parameters (215) in accordance with one or more embodiments, and the target is the IPR of the well and reservoir.

The neural network (600) output is compared to the associated input data target(s). The comparison of the neural network (600) output to the target(s) is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (600) output and the associated target(s). The loss function may also be constructed to impose additional constraints on the values assumed by the edges (604), for example, by adding a penalty term, which may be physics-based, or a regularization term. Generally, the goal of a training procedure is to alter the edge (604) values to promote similarity between the neural network (600) output and associated target(s) over the data set. Thus, the loss function is used to guide changes made to the edge (604) values, typically through a process called “backpropagation.”

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target(s) with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (604) values are no longer intended to be altered, the neural network (600) is said to be “trained”.

In one or more embodiments, the output (320) of the hybrid ML model (217) is the predicted IPR (240). In some embodiments, the second ML model (327) of the hybrid ML model (217) outputs the predicted IPR (240). As previously described, the second ML model (327) may either be directly or indirectly informed by the ML model inputs (300) in accordance with one or more embodiments. In the case of the former where the second ML model (327) is directly informed by the ML model inputs (300), the ML model inputs (300) may include field data (210) and the set of operation parameters (215). The field data (210) may include well data (202) describing properties of the well (e.g., wellbore flowing pressure, well diameter), fluid data (230) describing fluid within the reservoir (e.g., viscosity, oil-to-gas ratio), and reservoir data (235) describing the reservoir (e.g., reservoir temperature and reservoir pressure). The set of operation parameters may include well control parameters (203) defining the operation of the well (e.g., assigning a state to one or more production valves). The ML model inputs (300) listed herein may be considered inputs to the second ML model (327) alongside the set of evolved mathematical functions (330), where each function of the set of evolved mathematical functions (330) is itself a function of one or more variables represented by the ML model inputs (300). In this context, there are several possible interactions between the ML model inputs (300) and the set of evolved mathematical functions (330) during their mutual processing by the second ML model (327). By allowing the second ML model (327) direct access to the ML model inputs (300) alongside the set of evolved mathematical functions (330), the second ML model (327) may further extract patterns of (or “learn”) complex relationships between the ML model inputs (300) and the precise flow rate (i.e., the IPR) of a given well and reservoir that cannot be captured by mathematical functions alone. In other words, the second ML model (327) may use the ML model inputs (300) directly to modify, refine, and adjust the predicted flow rates provided by the set of evolved mathematical functions. The role of the second ML model (327), in this scenario, is to further extract complicated relationships between the ML model inputs (300) and the IPR to obtain more accurate predictions while maintaining the direct interpretability provided by the set of evolved mathematical functions (330).

Another possible interaction that is not mutually exclusive with the previously described interaction between the ML model inputs (300) and the set of evolved mathematical functions (330) is the following. A known feature of IPR of wells is the non-linear behavior arising at the bubble point pressure. On either side of the bubble point pressure (i.e., when the pressure is either less than or greater than the bubble point pressure), the IPR may be adequately represented by two significantly different functions in a piecewise manner. Consequently, complex changes in behavior of the IPR, such as the one presented by the bubble point pressure, may require different functions from the set of evolved mathematical functions to be applied in order to accurately predict IPR, depending on the value of one or more variables directly represented by the ML model inputs (300). Ultimately, this complex behavior in IPR can be accurately captured through the direct consideration of the ML model inputs (300) by the second ML model (327) by enabling piecewise combinations of the functions belonging to the set of evolved mathematical functions (330). The second ML model (327) may learn both which functions are applicable under a given condition (e.g., under a given reservoir pressure), and the transition points or thresholds that join one function to another (e.g., the bubble point pressure). Put differently, the second ML model (327) intelligently determines the domain of applicability, i.e., the location in the multidimensional parameter space spanned by the ML model inputs (300) in which one or more mathematical functions is valid. Further, the second ML model (327) may use this information to apply the appropriate function(s), given the location in the multidimensional parameter space. For example, in the vicinity of the bubble point pressure of a fluid, the second ML model (327) can select and apply a subset of functions from the set of evolved mathematical functions (330) that models the non-linear behavior characteristic of this specific condition (i.e., a thermophysical state of the fluid being near its bubble point pressure). Another possibility may be for a multiphase fluid containing some combination of gaseous, liquid, and solid particulates. In such a case, one or more functions in the set of evolved mathematical functions (330) may accurately describe only one phase of flowing fluid, and the second ML model (327) may intelligently combine these functions for a given well and reservoir. This feature provides a numerically tractable approach for modeling dynamically complex multiphase fluids. For example, the combination could be a piecewise function or a linear combination, or another type of combination not listed. A person skilled in the art will appreciate that other possible interactions between the inputs to the second ML model (327) may exist and the illustrations given above should not be considered limiting.

In one or more embodiments, the output (320) of the hybrid ML model (217) is the predicted IPR (240). In some embodiments, the second ML model (327) of the hybrid ML model (217) outputs the predicted IPR (240). As previously described, the second ML model (327) may either be directly or indirectly informed by the ML model inputs (300) in accordance with one or more embodiments. In the case of the latter where the second ML model (327) is indirectly informed by the ML model inputs (300), the only input to the second ML model (327) is the set of evolved mathematical functions (330). However, as each function of the set of evolved mathematical functions (330) is itself a function of one or more variables represented by the ML model inputs (300), the second ML model (327) may be considered indirectly informed by the ML model inputs (300). In this way, the set of evolved mathematical functions (330) may be considered as a type of feature engineering or pre-processing of the ML model inputs (300) such that further extraction of patterns (or “learning”) is more readily enabled for the second ML model (327). Under these circumstances, it is possible for the second ML model (327) to combine insight derived from the first ML model (325) into new relationships that better captures the predicted flow rate than any single function of the set of evolved mathematical functions (330). In one aspect, the IPR that is predicted by the second ML model (327) under these conditions is limited to transformations of the functions belonging to the set of evolved mathematical functions (330) by the second ML model (e.g., according to the activation functions of nodes and values of edges within the layers of an artificial neural network). By providing only the set of evolved mathematical functions (330) as inputs to the second ML model (327), rather than allowing the second ML model (327) direct access to the ML model inputs (300), a level of interpretability of the predicted IPR (240), given the ML model inputs (300), is more likely. It is also possible under these circumstances for the second ML model (327) to develop piecewise functions and linear combinations combining individual functions of the set of evolved mathematical functions (330), as well as other types of combinations not listed. Here, the values that determine transition points in the piecewise function (or possibly the weights associated with the elements of a linear combination) may be only indirectly inferred or extracted by the behavior of the set of evolved mathematical functions (330), which may change according to the values of their independent variables.

In one or more embodiments, training data for the second ML model (327) may include a collection of measured flow rates corresponding to different well and reservoir conditions gathered by the plurality of devices disposed within the oil and gas field or well environment. Alternatively, historical data from substantially similar or analogous reservoirs and wells including the parameters and data of interest (i.e., the independent variables of the set of evolved mathematical functions (330)) may be used alongside the corresponding measured flow rates.

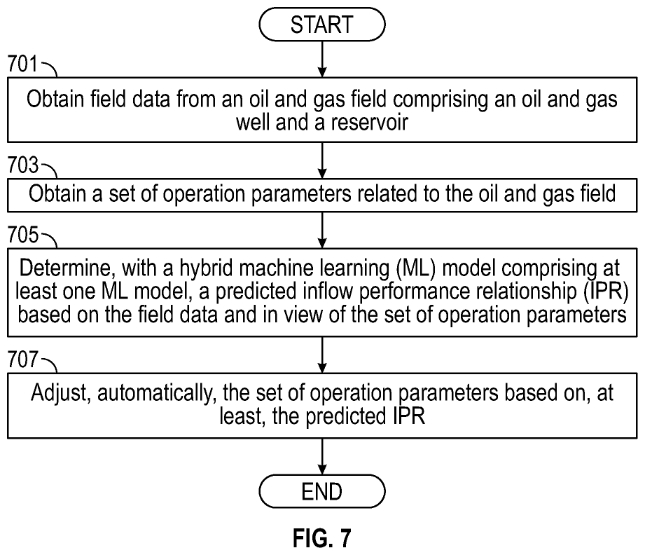

The process of evaluating field data and predicted inflow performance relationship (IPR) is summarized in the flow chart of FIG. 7. In Block 701, field data for an oil and gas field including an oil and gas well and a reservoir is obtained. The field data may include well data, reservoir data, and fluid data describing fluid in the well and in the reservoir. The field data is obtained by a plurality of devices disposed within the oil and gas field, within the well, and within or proximate to the reservoir. The well data may include the well depth, well diameter, the type of completion used, and the wellbore flowing pressure. The reservoir data may include information regarding its geometric shape, or the reservoir temperature and reservoir pressure. The fluid data may include the viscosity and density of one or more fluids, and the mass or volume ratios of different fluids that are present.

In one or more embodiments, the field data are pre-processed. Pre-processing may include numerical zing the data, scaling the data, selecting features from the data, and engineering features from the data.

In Block 703, a set of operation parameters related to the oil and gas field is obtained. The set of operation parameters may include well control parameters defining the operation of the well in the oil and the gas field via a well control system. The well control parameters may include defining, for example, the extent to which one or more inflow or production valves within the well is open or closed. Modifying the states of the well control parameters may be necessary for one or more operations at the well, such as for an injection operation, production operation, or maintenance operation. The well control system interacts with the plurality of devices disposed within the well and reservoir.

In Block 705, the field data and the set of operation parameters are processed by a hybrid machine learning (ML) model, including a first ML model, to predict the inflow performance relationship for the well and reservoir. Various embodiments of the hybrid ML model have been described with regards to FIGS. 4-6. The hybrid ML model outputs a prediction of the IPR, according to the set of operation parameters and in view of the field data. IPR may be considered in a variety of forms. For example, IPR may be considered in the form of a continuous analytic function such as a polynomial, rational function, a transcendental function, and a piecewise function, or any combination therein. IPR may further be represented by a differential equation or partial differential equation such that the family of solutions to the partial differential equation may each describe the IPR, the exact solution being discernible with a set of suitable boundary conditions and initial conditions. In one or more embodiments, the predicted IPR is not represented by an explicit mathematical function but is numerically approximated. Further, in one or more embodiments, the predicted IPR is a single value representing the flow rate calculated according to a given set of conditions, e.g., according to field data and in view of the operational state defined by set of operation parameters In other words, in one or more embodiments, the predicted IPR is just the flow rate (i.e., a single value) according to a set of conditions represented by the field data and set of operation parameters. In practice, however, the hybrid ML model will have extracted patterns or insights from (or “learned” the relationships between) various members of the field data and the set of operation parameters such that the hybrid ML model may determine a different predicted IPR under different conditions. In this way, it would be possible to construct a “classical” IPR curve presenting flow rates as a function of one or more variables using the predicted IPR (240), or to simply consider flow rates according to the values of one or more variables.

In Block 707, the set of operations parameters are adjusted (e.g., through interactions between the well control system of the well and the plurality of devices disposed within the well) to new values according to the predicted IPR. Depending on the goal at a particular oil and gas field, the adjustment of the set of operation parameters may be different. Owing to the general applicability of IPR in relating key characteristics in wells and their associated subsurface formations, IPR is used in many applications, for example, reservoir management, well design, fluid production optimization, and well-reservoir modeling. For example, based on the IPR, the set of operation parameters may be adjusted to limit the flow of fluids (e.g., by closing certain valves) in order to perform a maintenance operation. In another case, based on the IPR, the set of operation may be adjusted to increase flow of fluids (e.g., by opening certain valves) to lower the wellbore flowing pressure and thereby increase fluid production. Any such adjustment may be performed automatically and autonomously, or may be done manually, or may be checked by a “human-in-the-loop.”

The steps depicted in FIG. 7 may be repeated arbitrarily numerous times, in accordance with one or more embodiments. In other words, the steps depicted in FIG. 7 may be repeated to obtain new predictions of the IPR for the well and reservoir as their individual conditions change over time and their mutual interactions evolve.

Embodiments of the present disclosure may provide at least one of the following advantages. As previously described, the inflow performance relationship (IPR) for a given well and reservoir is sensitive to the conditions of the well, reservoir, and fluid within the well and reservoir. As such, complex interactions exist between the features describing each of these elements of an oil field, and accurately predicting IPR is a difficult and laborious task. Further, the state and behavior of well environment may be transient according to the operations of the well, the time evolution of the reservoir (e.g., depletion of reservoir fluid and pressure and geological or seismic activity). Changing the behavior of a well system may be achieved in many circumstances by altering well pressure. Typically, modifying the pressure within a well system is directly achievable through the configuration of one or more devices and valves disposed within the well, possibly subject to constraints imposed by the reservoir itself. However, the outcome of modifying the well pressure with regard to fluid flow depends on accurate information provided by IPR. However, as noted above and further described below, IPR is commonly difficult to characterize.

Typical examples of methods to handle the complexity of the interactions between wells, reservoirs, and fluids, with regard to determining IPR, may be grouped into empirical methods, mechanistic methods, and numerical or simulation-based methods. Both empirical and mechanistic methods involve capturing the behavior of fluid flow between a reservoir and well via mathematical equations. Empirical methods involve deriving functions from observed data and measurements from wells and reservoirs, while mechanistic methods involve deriving analytic relationships for fluid flow between a reservoir and well from first principles. Both of these methods typically involve simplifying assumptions regarding the reservoir, well, and fluid, in addition to extrapolating from limited data into domains where the methods may not be reliable, for example, in the case of complex reservoirs. By contrast, embodiments of the instant disclosure do not make strict assumptions about the behavior and interactions between wells, reservoirs, and fluids, and instead the hybrid ML model extracts patterns or “learns” this behavior through the machine learning methods employed. In addition, no extrapolation is necessary, as the training data is constructed to be representative of the expected conditions of the given well and reservoir at the time of deployment of the model.

Numerical and simulation-based methods involve building three dimensional representations of reservoirs, wells, and fluids according to variety of conditions. In order for the simulation to be informative for a given reservoir, well, and fluid, detailed knowledge about the particular well, reservoir, and fluid is needed, in addition to accurate information regarding the behavior and interactions of these elements. Further, sub-grid physical assumptions and heuristics are commonly employed to capture behavior on scales too small to simulate, which may lead to simulations that are not flexible across large dynamic ranges. Lastly, the construction of such simulations is typically time consuming. By contrast, embodiments of the instant disclosure do not require detailed knowledge of the interactions and behaviors of wells, reservoirs, and fluids, and instead the hybrid ML model extracts patterns or “learns” this behavior through the machine learning methods employed. In addition, no sub-grid physical assumptions or heuristics are needed, as the hybrid ML model may be simply retrained to capture changes on different dynamic scales. Lastly, though training timescales may involve a substantial duration, most machine learning algorithms are exceptionally fast at deployment.

The addition of genetic programming, used to evolve a set of mathematical functions that model the IPR for the well and reservoir, increases the likelihood for easily interpreted predictions for the IPR, in contrast to “black box” algorithms that do not enable immediate understanding of how one or more predictions is made. The set evolved mathematical functions provide direct relationships linking the data and parameters associated with the well and reservoir to the predicted IPR. Further, the hybrid ML model is flexible in its ability to accurately predict IPR. The hybrid ML model allows combining one or more functions from the set of evolved mathematical functions, according to different learned patterns, and directly adjusting the predicted flow rates based on learned patterns in the model inputs, in accordance with one or more embodiments.

By continuously receiving and processing field data with a hybrid ML model, the predicted IPR can be maintained in an optimally accurate state greatly reducing the cost and time required to determine the IPR for a given well and reservoir, and accordingly, make decisions to change the state(s) operation parameters defining the operation of the well.

Embodiments may be implemented on a computer system. FIG. 8 is a block diagram of a computer system (802) used to provide computational functionalities associated with described algorithms, methods, functions, processes, flows, and procedures as described in the instant disclosure, according to one or more embodiments. The illustrated computer (802) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the ML model may be implemented on an edge computing device in order to quickly provide optimal sets of transceiver parameters and well operation parameters to associated devices or their controllers.

Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804) includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). The memory may be a non-transitory computer readable medium. For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), wherein each computer (802) communicates over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining field data from an oil and gas field comprising an oil and gas well and a reservoir;
obtaining a set of operation parameters related to the oil and gas field;
determining, with a hybrid machine learning (ML) model comprising at least one ML model, a predicted inflow performance relationship (IPR) based on the field data and in view of the set of operation parameters; and
adjusting, with a well controller, the set of operation parameters based on, at least, the predicted IPR.

2. The method of claim 1:
wherein the set of operation parameters comprises well control parameters defining the operation of the well.

3. The method of claim 1:
wherein the field data comprises well data, reservoir data, and fluid data describing fluid in the well and the reservoir.

4. The method of claim 1:
wherein the hybrid ML model comprises a first ML model that determines at least one mathematical function describing a predicted flow rate, based on, at least, the field data,
wherein the hybrid ML model further comprises a second ML model that determines the predicted IPR based on, at least, the at least one mathematical function, the field data, and the set of operation parameters.

5. The method of claim 4, wherein the first ML model uses genetic programming techniques to evolve a plurality of mathematical functions describing the predicted flow rate from the reservoir and well, based on, at least, the field data.

6. The method of claim 4, wherein the second ML model is an artificial neural network.

7. The method of claim 3, wherein the reservoir data comprises reservoir pressure and reservoir temperature.

8. A system, comprising:
an oil and gas field comprising an oil and gas well and a reservoir, wherein operation of the oil and gas field is defined, at least in part, by a set of operation parameters;
a plurality of field devices disposed throughout the oil and gas field, the plurality of field devices gathering field data;
a control system configured to adjust one or more field devices in the plurality of field devices; and
a computer configured to:
obtain the field data from the oil and gas field;
obtain the set of operation parameters for the oil and gas field;
determine, with a hybrid machine learning (ML) model comprising at least one ML model, a predicted inflow performance relationship (IPR) based on the field data and in view of the set of operation parameters, and
adjust, automatically, the set of operation parameters based on, at least, the predicted IPR.

9. The system of claim 8:
wherein the set of operation parameters comprises well control parameters defining the operation of the well.

10. The system of claim 8:
wherein the field data comprises well data, reservoir data, and fluid data describing fluid in the well and the reservoir.

11. The system of claim 8:
wherein the hybrid ML model comprises a first ML model that determines at least one mathematical function describing a predicted flow rate, based on, at least, the field data,
wherein the hybrid ML model further comprises a second ML model that determines the predicted IPR based on, at least, the at least one mathematical function, the field data, and the set of operation parameters.

12. The system of claim 11, wherein the first ML model uses genetic programming techniques to evolve mathematical functions describing the predicted flow rate from the reservoir and the well, based on, at least, the field data.

13. The system of claim 11, wherein the second ML model is an artificial neural network.

14. A non-transitory computer-readable memory comprising computer-executable instructions stored thereon that, when executed on a processor, cause the processor to perform steps comprising:
obtaining field data from an oil and gas field comprising an oil and gas well and a reservoir;
obtaining a set of operation parameters related to the oil and gas field;
determining, with a hybrid machine learning (ML) model comprising at least one ML model, a predicted inflow performance relationship (IPR) based on the field data and in view of the set of operation parameters; and
adjusting, automatically, the set of operation parameters based on, at least, the predicted IPR.

15. The non-transitory computer-readable memory of claim 14, wherein the set of operation parameters comprises well control parameters defining the operation the well.

16. The non-transitory computer-readable memory of claim 14, wherein the field data comprises well data, reservoir data, and fluid data describing fluid in the well and the reservoir.

17. The non-transitory computer-readable memory of claim 14:
wherein the hybrid ML model comprises a first ML model that determines at least one mathematical function describing a predicted flow rate, based on, at least, the field data,
wherein the hybrid ML model further comprises a second ML model that determines the predicted IPR based on, at least, the at least one mathematical function, the field data, and the set of operation parameters.

18. The non-transitory computer-readable memory of claim 17, wherein the first ML model uses genetic programming techniques to evolve mathematical functions describing the predicted flow rate from the reservoir and the well, based on, at least, the field data.

19. The non-transitory computer-readable memory of claim 17, wherein the second ML model is an artificial neural network.

20. The non-transitory computer-readable memory of claim 16, wherein the reservoir data comprises reservoir pressure and reservoir temperature.
